(19) United States
(12) Patent Application Publication
(10) Pub. No.: US 2016/0345049 A1
(43) Pub. Date: Nov. 24, 2016

(54) METHOD AND DEVICE FOR SWITCHING CHANNEL

(71) Applicant: Lemobile Information Technology (Beijing) Co., Ltd, Beijing (CN)

(72) Inventors: Xizhe XIAO, Beijing (CN); Xiaobin WANG, Beijing (CN); Shixing LI, Beijing (CN); Peng GAI, Beijing (CN); Fei WANG, Beijing (CN); Bo LI, Beijing (CN)

(21) Appl. No.: 15/158,509

(22) Filed: May 18, 2016

(30) Foreign Application Priority Data
May 19, 2015 (CN) 201510257898.5

(51) Int. Cl. H04N 21/422; H04M 1/725; H04N 21/414; G06F 3/01; H04N 21/482

(52) U.S. Cl. CPC H04N 21/42224; G06F 3/017; H04N 21/482; H04N 21/41407; H04M 1/72522

(57) ABSTRACT

The embodiments of the disclosure provide a method and device for switching channel. The method comprises: when a first touch gesture for a first channel is detected, loading a first channel display window; displaying channel information of the first channel on the first channel display window; according to a detected second touch gesture, moving at least a portion of channel information of the first channel out of and moving at least a portion of channel information of a second channel into the first channel display window; and when the moved-out channel information of the first channel or the moved-in channel information of the second channel satisfies a predefined switching condition, playing back video data of the second channel. The displaying of channel information informs user of the channel which can be triggered by the touch gesture, and the switching of channel information informs user of the timing of channel switch.

### CROSS-REFERENCE TO RELATED APPLICATIONS

The present disclosure is based upon and claims priority to Chinese Patent Applications No. CN201510257898.5 filed May 19, 2015, the entire contents of all of which are incorporated herein by reference.

### FIELD OF TECHNOLOGY

The disclosure relates to the field of video processing technologies, and particularly to a method for switching channel and a device for switching channel.

### BACKGROUND

With rapid development of internet, an internet video application can be used not only to watch live programs, but also to search a great number of network resources for a desirable program genre of a user through internet functions. Therefore, the internet video application has been widely used in people's life.

In a video application, most of interactions of a user interface (UI) are based upon a touch-screen mode, including channel switch.

Currently, the way of gesture channel-switching is to add a gesture recognition function to a UI Control. In other words, a judgment for a gesture in a specific direction is added to a specific region of the UI Control, and upon the judgment the channel-switching may be triggered. During the switching, the channel is directly switched by the video application, which may easily result in an incorrect manipulation, such as incorrect switching. In the case of the incorrect manipulation, the user will necessarily switch once more, resulting in the waste of resources for an electronic terminal.

### SUMMARY

In the view of above problems, the embodiments of the disclosure are proposed to provide a method for switching channel and a corresponding device for switching channel, for overcoming or at least partially solving above problems.

To address above problems, the embodiment of the disclosure provides a method for switching channel, including:
when a first touch gesture for a first channel is detected, loading a first channel display window;
displaying channel information of the first channel on the first channel display window;
according to a detected second touch gesture, moving at least a portion of channel information of the first channel out of and moving at least a portion of channel information of a second channel into the first channel display window; and
when the moved-out channel information of the first channel or the moved-in channel information of the second channel satisfies a predefined switching condition, playing back video data of the second channel.

The embodiment of the disclosure also provides a device for switching channel, including:
a window loading module, configured to, when a first touch gesture for a first channel is detected, load a first channel display window;
a first channel information displaying module, configured to display channel information of the first channel on the first channel display window;
a channel information switching module, configured to, according to a detected second touch gesture, move at least a portion of channel information of the first channel out of and move at least a portion of channel information of a second channel into the first channel display window; and
a second channel playback module, configured to, when the moved-out channel information of the first channel or the moved-in channel information of the second channel satisfies a predefined switching condition, play back video data of the second channel.

The embodiment of the disclosure also provides an electronic terminal for switching channel, characterized in that, the electronic terminal includes:
at least one processor;
a memory for storing at least one instruction executable by the processor;
   wherein the processor is configured to perform:
when a first touch gesture for a first channel is detected, loading a first channel display window;
displaying channel information of the first channel on the first channel display window; according to a detected second touch gesture, moving at least a portion of channel information of the first channel out of and move at least a portion of channel information of a second channel into the first channel display window; and
when the moved-out channel information of the first channel or the moved-in channel information of the second channel satisfies a predefined switching condition, playing back video data of the second channel.

The embodiments of the disclosure may have following advantages:

According to the embodiments of the disclosure, in channel switch, it is possible to move at least a portion of channel information of the first channel out of and move at least a portion of channel information of the second channel into the first channel display window. If the channel information of the first channel or the channel information of the second channel satisfies the switching condition, the second channel may be played back. The displaying of channel information may inform the user of the channel which can be triggered by the touch gesture, and the switching of channel information may inform the user of the timing of channel switch. Therefore, possibility of incorrect manipulation can be greatly reduced, then more switches are avoided and the waste of resources for an electronic terminal is lowered.

### BRIEF DESCRIPTION OF THE DRAWINGS

FIG. 1 is a flow chart of a method for switching channel according to a first embodiment of the disclosure;

FIG. 2A to FIG. 2C are schematic diagrams of the switching of channel information according to the embodiment of the disclosure;

FIG. 3 is a flow chart of a method for switching channel according to a second embodiment of the disclosure;

FIG. 4A is a schematic diagram of the displaying of channel information according to the embodiment of the disclosure;

FIG. 4B is an illustrative flow chart of the channel switch according to the embodiment of the disclosure; and

FIG. 5 is a block diagram of a device for switching channel according to an embodiment of the disclosure.

### DESCRIPTION OF THE EMBODIMENTS

In order to more clearly understand above objects, features and advantages of the disclosure, hereinafter the disclosure will be further described in detail in conjunction with accompanying drawings and specific implementations.

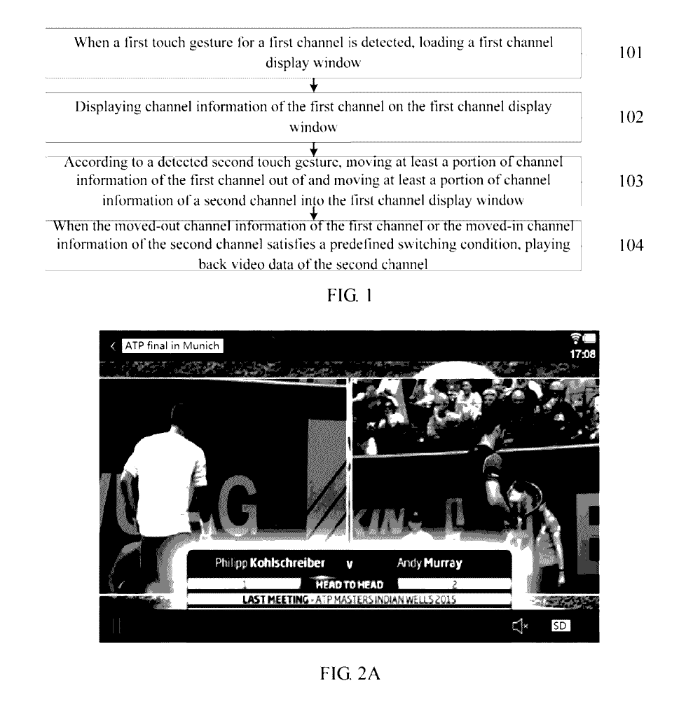

With reference to FIG. 1, it shows a flow chart of a method for switching channel according to a first embodiment of the disclosure. The method may particularly include steps of:

Step 101, when a first touch gesture for a first channel is detected, loading a first channel display window.

Step 102, displaying channel information of the first channel on the first channel display window.

It should be explained that, the embodiment of the disclosure can be applicable to electronic terminals, such as mobile phone, tablet, smart watch, etc., which should not restricted by the embodiment of the disclosure.

The electronic terminal may include an operating system such as Android, IOS or WindowsPhone, which may support an operation of the video application, such that the video application may support a live channel function, for example.

Moreover, the electronic terminal may be provided with a touch screen and support a touch operation. Herein, the touch screen may also be known as “touch control screen” or “touch control panel”, which could be a sensing liquid crystal display device receiving an input signal of a contact terminal. It may particularly include a vector pressure sensing technology touch screen, a resistance technology touch screen, a capacitor technology touch screen, an infrared technology touch screen, a surface acoustic wave technology touch screen, etc, which should not be restricted by the embodiment of the disclosure.

In a specific implementation, a user may trigger a loading of first channel display window by the first touch gesture such as single-click, double-click and the like, to display the channel information of the first channel which is information in relation to the channel.

It should be explained that the first channel is a channel to which video data being played pertains.

The first channel display window can be used to display the channel information which may include channel image and/or channel text.

Further, the first channel display window may include a first image floating layer and/or a first text floating layer.

The first image floating layer may be used to load image information. In the embodiment of the disclosure, the first image floating layer may be used to display a channel image which could be image data reflecting a feature of this channel, such as image data which contains LOGO of a satellite channel and which can be used to identify the channel.

The first text floating layer may be used to load text information. In the embodiment of the disclosure, the first text floating layer may be used to display channel text which could be text data reflecting a feature of this channel, such as a channel name. The channel text may contain program contents, such as program name and broadcast time of program.

In Android system, the image floating layer may be a custom class inherited from an ImageView class, and the text floating layer may be a custom class inherited from a TextView class.

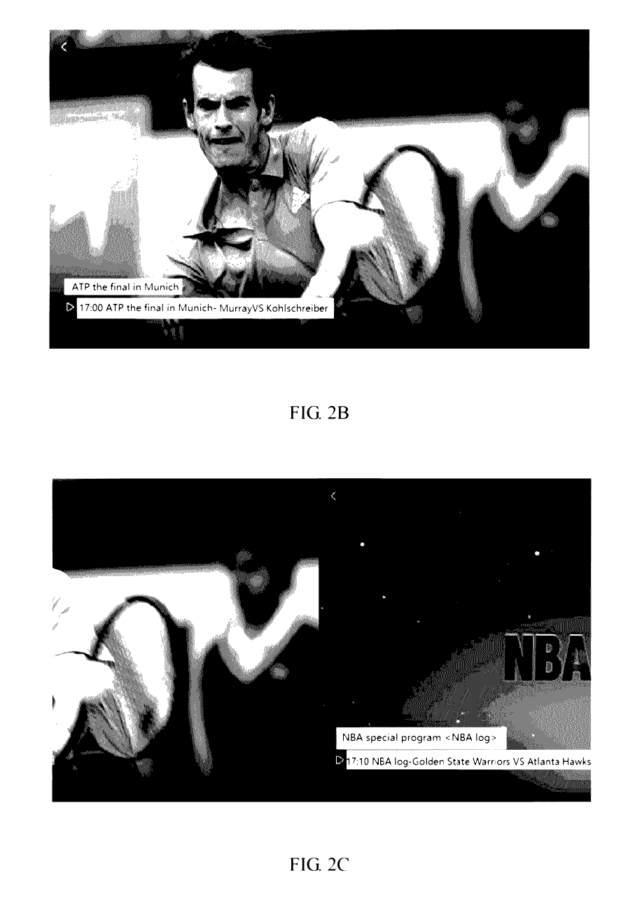

For example, as shown in FIG. 2A, the first channel “tennis” is playing an “ATP Munich final” program. If a user clicks on an interface for playback, then as shown in FIG. 2B, the first channel display window may be loaded to display the channel image and the channel text “ATP Munich final” of the first channel.

Step 103, according to a detected second touch gesture, moving at least a portion of channel information of the first channel out of and moving at least a portion of channel information of a second channel into the first channel display window.

In the embodiment of the disclosure, the user may trigger the channel switch by the second touch gesture.

In a preferred embodiment of the disclosure, Step 103 may include sub-steps of:

Sub-step S11, when the second touch gesture is detected, determining the second channel at a second position in a channel module list of a channel category to which the first channel pertains according to a direction of the second touch gesture, the second position being adjacent to a first position of the first channel.

The channel module list (ChannelModule) is abstractive data structure for channels, including a channel list of all the channels under a certain channel category. The channel list may particularly include data such as channel IDs, channel names, stream address, channel image and positional order among channels.

Since the size of the channel module list (ChannelModule) is very large, generally, a server may be requested for partial data of the channel module list (ChannelModule). If there is no necessary data at local host, then the server may be requested again.

Of course, it is also possible to request for all the data of the channel module list (ChannelModule). This should not be restricted by the embodiment of the disclosure.

The channel module list (ChannelModule) obtained from the server usually is a Json (JavaScript Object Notation) format. Then relative information may be obtained after being parsed.

In the channel module list, the data in relation to the first channel may be obtained by the first position (index).

Herein, the index is equivalent to a subscript of an array. A corresponding item in the array (i.e., channel module list) may be located by the subscript.

In a specific implementation, a touch event for calculating the second touch gesture may judge the direction. The touch event may include a down event (Down), a move event (Move), an up event (Up), etc.

In an example, the down event (Down) may be preferentially selected to calculate a sliding direction. If the up event (Up) is detected, then the up event (Up) may be preferentially selected to cooperatively calculate the sliding direction with the down event (Down). If the up event (Up) is detected, then a recently occurred move event (Move) may be used to cooperatively calculate the sliding direction with the down event (Down).

The direction of the second touch gesture may refer to a sliding direction, which is pointed to a direction from a position of a prior occurred touch event towards a position of a later occurred touch event.

For example, on the condition that the down event (Down) occurs at a position a (x1, y1) at time t1, the up event (Up) occurs at a position b (x2, y2) at time t2, and t1 is earlier than t2, then the direction may pointing to b from a, namely a→b.

The term “adjacent” may indicate that the second position and the first position pertain to one channel category, wherein the second position may be positioned on the left side of the first position (for example, previous channel) or on the right side of the first position (for example, next channel).

For example, if the direction of the second touch gesture is from left to right or from down to up, then the second position may be positioned on the left side of the first position; and if the direction of the second touch gesture is from right to left or from up to down, then the second position may be positioned on the right side of the first position.

Sub-step S12, obtaining channel information of the second channel.

After the position of the second channel is located, then it is possible to search the channel module list (ChannelModule) for the corresponding channel information. If not found, then it is possible to send a channel identifier of the second channel to the server to request for the channel information of the second channel.

Sub-step S13, according to the second touch gesture, moving at least a portion of channel information of the first channel out of and moving at least a portion of channel information of the second channel into the first channel display window.

In a specific implementation, it is possible to move at least a portion of channel information of the first channel out of and move at least a portion of channel information of the second channel into the first channel display window, in accordance with parameters of the second touch gesture such as direction, sliding distance and sliding rate, such that the channel information of the first channel and the second channel can be switched.

In an embodiment, a direction of switching the channel information of the first channel and the second channel may be equivalent to the direction of the second touch gesture.

In another embodiment, if the sliding distance and the sliding rate become increased, then the rate of moving out the channel information of the first channel and moving in the channel information of the second channel may become faster; on the contrary, if the sliding distance and the sliding rate become reduced, then the rate of moving out the channel information of the first channel and moving in the channel information of the second channel may become slower.

Further, in the embodiment of the disclosure, it is possible to move at least a portion of channel image of the first channel out of and move at least a portion of channel image of the second channel into the first image floating layer in accordance with the second touch gesture; and it is possible to move at least a portion of channel text of the first channel out of and move at least a portion of channel text of the second channel into the first text floating layer in accordance with the second touch gesture.

For example, as shown in FIG. 2C, if the direction of the second touch gesture is from right to left, then the channel information of the first channel “tennis” may be moved out of and the channel information of the second channel “basketball” may be moved into the first channel display window from right to left.

Step 104, when the moved-out channel information of the first channel or the moved-in channel information of the second channel satisfies a predefined switching condition, playing back the second channel.

When the embodiment of the disclosure is applied, it is possible to predefine the switching condition. For example, the move-out channel image of the first channel or the moved-in channel image of the second channel exceeds a ratio (for example, 1/2) or exceeds an area. As another example, the move-out channel text of the first channel exceeds a boundary or the moved-in channel text of the second channel exceeds a position.

When the switching condition is satisfied, the playback channel may be switched; otherwise, the first channel display window may be removed, followed by fading out the channel information of first channel and channel information of second channel and then a player keeps on playing back a program of the first channel.

In a preferred embodiment of the disclosure, Step 104 may include sub-steps of:

Sub-step S21, when stream address of the second channel is being loaded by a player, displaying the channel information of the second channel on the first channel display window.

Herein, the stream address of the second channel is obtained by searching the channel module list of the channel category to which the second channel pertains by the player.

Sub-step S22, when stream address of the second channel is completely loaded by a player, removing the first channel display window.

The player may load video information. Then in the embodiment of the disclosure, the player may load the first channel and the second channel.

In Android system, the player may be a custom class inherited from a VeidoView class.

After the position of the second channel is located, then the channel module list (ChannelModule) is searched for the corresponding stream address. The player may load the stream address for example on the basis of M3U8 standard, and request for the video data of the second channel to play back.

Every operation of switching the channel may result in the switch between different code streams. In the current manners of switching channel, a black screen may appear for a while prior to playback, which results in an inferior experience.

Therefore, in the embodiment of the disclosure, while the stream address is loaded by the player, relevant channel information may be loaded in the first channel display window. For example, while the channel texts are loaded in the first text floating layer, the channel images may be loaded in the first image floating layer.

When the player completely loads the stream address and begins playing back the video, the channel display window may be removed to gradually fade out the channel information such as channel texts and channel images, followed by playing back a program of a second video without the black screen.

According to the embodiment of the disclosure, in the switching of channel, at least a portion of channel information of the first channel may be moved out of and at least a portion of channel information of the second channel may be moved into the first channel display window. If the channel information of the first channel or the channel information of the second channel satisfies the switching condition, the second channel may be played back. The displaying of channel information may inform the user of the channel which can be triggered by the touch gesture. And since the floating layer displays the channel information during the channel switch, the user can be given a prompt that the channel switch is being triggered. The switching of channel information may inform the user of the timing of channel switch. Therefore, possibility of incorrect manipulation can be greatly reduced, then more switches are avoided and the waste of resources for an electronic terminal is lowered.

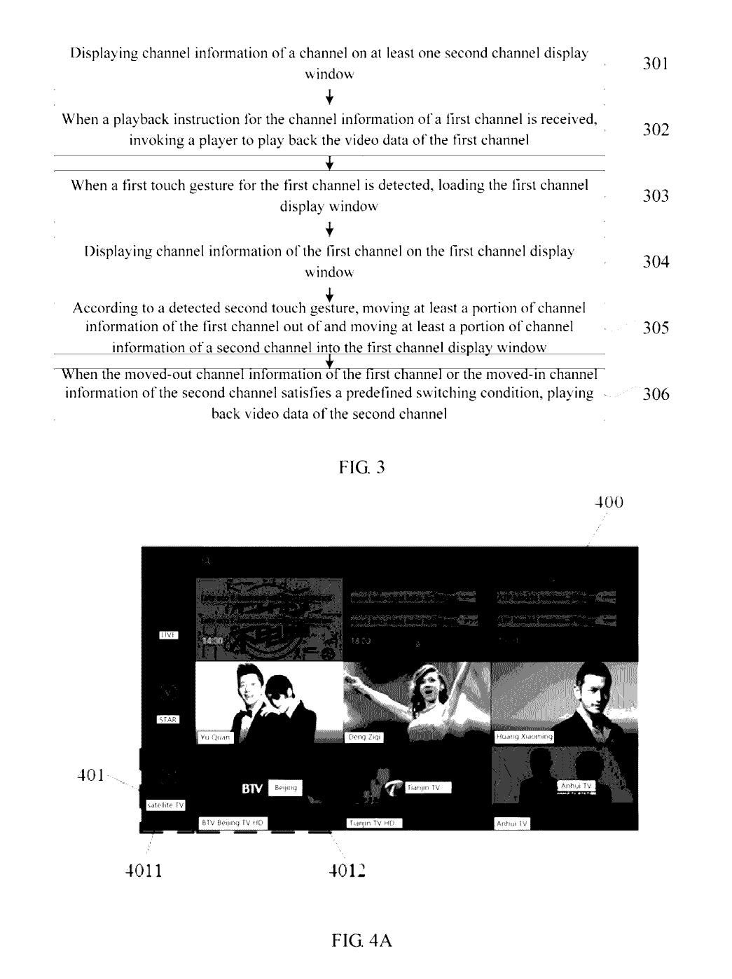

With reference to FIG. 3, it shows a flow chart of a method for switching channel according to a second embodiment of the disclosure. The method can be applicable to electronic terminals, such as mobile phone, tablet, smart watch, etc., which should not restricted by the embodiment of the disclosure.

The electronic terminal may include an operating system such as Android, IOS or WindowsPhone, which may support an operation of the video application, such that the video application may support a live channel function, for example.

A display interface of the electronic terminal may include at least one category channel display region which can be used to display information of a channel category.

Further, the category channel display region may include a first display sub-region and at least a second display sub-region. The first display sub-region may be used to display a channel category identifier, the second display sub-region may be used to display the second channel display window, and the second channel display window may be used to display channel information corresponding to a channel in the channel category.

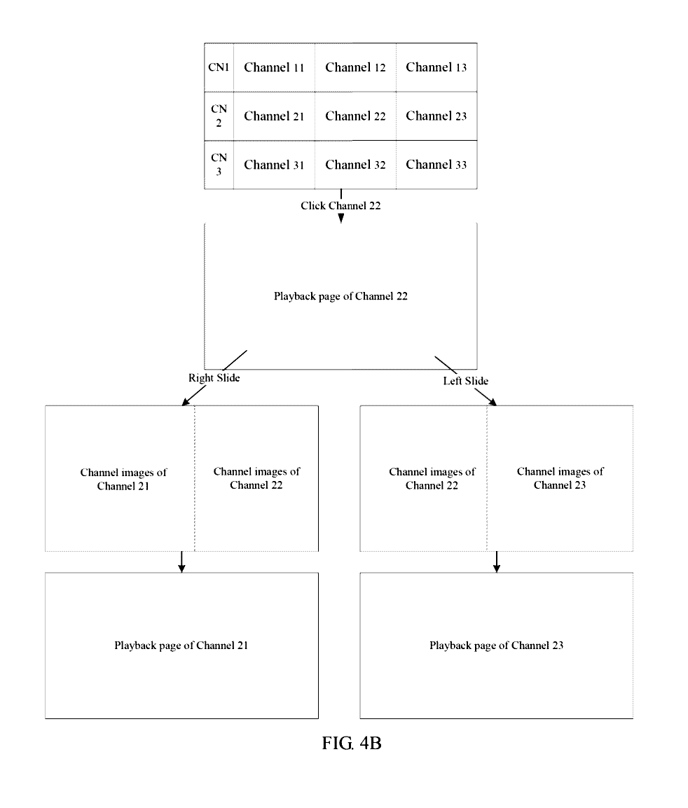

For example, as shown in FIG. 4A, a display interface 400 may include three category channel display regions, such as a category channel display region 401 which is used to display information in a satellite channel category. In a first display sub-region 4011 of the category channel display region 401, a channel category identifier “ [symbol] ” (satellite TV) and its LOGO (icon) of the satellite channel category is displayed. Further, the category channel display region 401 may include three second display sub-regions, such as a second display sub-region 4012. A second channel display window of the second display sub-region 4012 may display the channel information corresponding to a BTV HD channel.

The method may particularly include steps of:

Step 301, displaying channel information of a channel on at least one second channel display window.

In a specific implementation, if a user clicks to enter a live-broadcasting page of a video application, the video application may request a server for a channel module list (ChannelModule) of the at least one channel category, and select to display at least one piece of channel information from the channel module list (ChannelModule). Herein, the channel of displaying the channel information may include the first channel.

Moreover, the second channel display window may include a second image floating layer and/or a second text floating layer.

The second image floating layer may load image information. Then in the embodiment of the disclosure, the second image floating layer may be used to display channel images which could be image data reflecting a feature of this channel.

The second text floating layer may load text information. Then in the embodiment of the disclosure, the second text floating layer may be used to display channel texts which could be text data reflecting a feature of channel or program, such as a channel name, a program name, etc.

Step 302, when a playback instruction for the channel information of a first channel is received, invoking a player to play back the video data of the first channel.

In a specific application, the user may trigger the playback instruction of the first channel by clicking the channel information of first channel or clicking a playback control.

In a preferred embodiment of the disclosure, Step 302 may include sub-steps of:

Sub-step S31, sending a channel module list of a channel category to which the first channel pertains and a first position of the first channel in the channel module list to the player.

In the embodiment of the disclosure, it is possible to send the channel module list (ChannelModule) of the channel category to which the first channel pertains and the first position (index) of the first channel in the channel module list to the player, such that the player may obtain stream address of first channel and second channel by locating the first position (index) in the channel module list (ChannelModule), and channels in the same channel category can switched in the first channel display window different from the second channel display window. In other words, channels are switched between two different pages.

Of course, in addition to the channel module list of the channel category to which the first channel pertains, it is also possible to send a channel module list of a channel category to which another channel pertains to the player, to switch between channels of different channel categories. This should not be restricted by the embodiment of the disclosure.

Sub-step S32, loading the first channel display window;

In the embodiment of the disclosure, the first channel display window can be loaded according to information such as a custom size and position.

For example, a corresponding first text floating layer may be loaded according to information such as a custom size and position, and a corresponding first image floating layer may be loaded according to information such as a custom size and position.

Sub-step S33, when the stream address of the first channel is being loaded by the player, displaying the channel information of the first channel on the first channel display window.

Sub-step S34, when the stream address of the first channel is completely loaded by the player, removing the first channel display window.

Herein, the stream address of the first channel may be obtained by locating the first position in the channel module list of the channel category to which the first channel pertains by the player.

The player may search the channel module list (ChannelModule) for relevant stream address. Then it is possible to load the stream address on the basis of M3U8 standard and request for the video data of the second channel to play back.

The player may be invoked to load code stream when the channel is initially played. In the current manners of loading channel, a black screen may appear for a while prior to playback, which results in an inferior experience.

Therefore, in the embodiment of the disclosure, while the player is invoked to load the stream address, relevant channel information may be loaded in the first channel display window. For example, while the channel texts are loaded in the first text floating layer, the channel images may be loaded in the first image floating layer.

When the player completely loads the stream address and begins playing back the video, the first channel display window be removed to gradually fade out the channel information such as channel texts and channel images, followed by playing back a program of the first channel without the black screen.

In the meanwhile, since the channel information of the first channel displayed in the display interface is the same as the channel information of first channel the displayed when loading the stream address, a smooth transition of the switching operation of the player may be improved.

Step 303, when a first touch gesture for the first channel is detected, loading the first channel display window.

Step 304, displaying channel information of the first channel on the first channel display window.

Step 305, according to a detected second touch gesture, moving at least a portion of channel information of the first channel out of and moving at least a portion of channel information of a second channel into the first channel display window.

Step 306, when the moved-out channel information of the first channel or the moved-in channel information of the second channel satisfies a predefined switching condition, playing back the second channel.

In order to better understand the embodiment of the disclosure by those skilled in the art, the method for switching channel according to the embodiment of the disclosure may described hereinafter by way of a specific example.

As shown in FIG. 4B, a display region has three channel categories, channel category identifiers of which are category navigation 1, category navigation 2 and category navigation 3, respectively. Each of the channel categories has three channels. In other words, the channel category of category navigation 1 includes a channel 11, a channel 12 and a channel 13, the channel category of category navigation 2 includes a channel 21, a channel 22 and a channel 23, and the channel category of category navigation 3 includes a channel 31, a channel 32 and a channel 33.

When the user clicks channel information of the channel 22, a home page (a page of the display region) may send a channel module list of the channel category to which the channel 22 pertains to a playback page (a page of the player). The channel module list contains a channel ID, a channel name, stream address of the channel 22 and channel images.

As could be seen, the channel module list of playback page is consistent with the channel module list of home page, and the channels under a channel category can be switched.

Of course, in this example, by sending the channel module lists of the channel categories, the channels under channel categories can be switched additionally.

When the first touch gesture is detected in the playback page of the channel 22, then the channel image of the channel 22 may be displayed on the image floating layer; and when the second touch gesture is detected, then the channel image may slide in a direction corresponding to a sliding gesture according to the channel module list.

If the second touch gesture is directed to a rightward slide, then the channel image of the channel 21 may be switched in the image floating layer. When an area of the channel image of the channel 21 exceeds 1/2, the stream address of the channel 21 may be loaded to switch video data of channel 22 into video data of channel 21 in the playback page.

If the second touch gesture is directed to a leftward slide, then the channel image of the channel 23 may be switched in the image floating layer. When an area of the channel image of the channel 23 exceeds 1/2, the stream address of the channel 23 may be loaded to switch video data of channel 22 into video data of channel 23 in the playback page.

It should be explained that the method embodiments as described above, for the purpose of brief description, are described as a series of combined actions. However, it should be appreciated by those skilled in the art that the embodiments of the disclosure should not be restricted by the sequence of the actions as set forth, since some of actions could be performed in different sequence or simultaneously according to the embodiments of the disclosure. Moreover, it should also be appreciated by those skilled in the art that, the embodiments as described in the specification are preferred embodiments and actions concerned are not necessarily required in the embodiments of the disclosure.

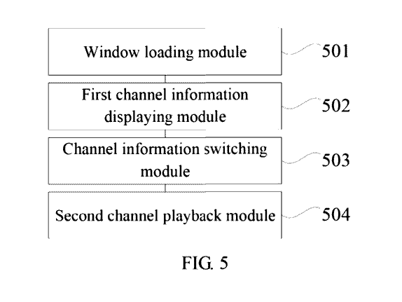

With reference to FIG. 5, it shows a block diagram of a device for switching channel according to an embodiment of the disclosure. The device may particularly include following modules:

a window loading module 501, configured to, when a first touch gesture for a first channel is detected, load a first channel display window;

a first channel information displaying module 502, configured to display channel information of the first channel on the first channel display window;

a channel information switching module 503, configured to, according to a detected second touch gesture, move at least a portion of channel information of the first channel out of and move at least a portion of channel information of a second channel into the first channel display window; and

a second channel playback module 504, configured to, when the moved-out channel information of the first channel or the moved-in channel information of the second channel satisfies a predefined switching condition, play back video data of the second channel.

In a preferred embodiment of the disclosure, the channel information switching module 503 may include following sub-modules:

a second channel determining sub-module, configured to, when the second touch gesture is detected, determine the second channel at a second position in a channel module list of a channel category to which the first channel pertains according to a direction of the second touch gesture, the second position being adjacent to a first position of the first channel;

a channel information obtaining sub-module, configured to obtain channel information of the second channel; and

a channel information moving sub-module, configured to, according to the second touch gesture, move at least a portion of channel information of the first channel out of and move at least a portion of channel information of the second channel into the first channel display window.

In a preferred embodiment of the disclosure, the second channel playback module 504 may include following sub-modules:

a first displaying sub-module, configured to, when stream address of the second channel is being loaded by a player, display the channel information of the second channel on the first channel display window; and

a first removing sub-module, configured to, when stream address of the second channel is completely loaded by a player, remove the first channel display window.

Herein, the stream address of the second channel is obtained by searching the channel module list of the channel category to which the second channel pertains by the player.

In a specific implementation, the current display interface of the electronic terminal may include at least one category channel display region, the category channel display region may include a first display sub-region and at least one second display sub-region, the first display sub-region may be used to display a channel category identifier, the second display sub-region may be used to display a second channel display window, and the second channel display window may be used to display channel information corresponding to a channel in the channel category.

In a preferred embodiment of the disclosure, the device may further include following modules:

a second channel information displaying module, configured to display channel information of a channel on at least one second channel display window, the channel including a first channel; and

a first channel playback module, configured to, when a playback instruction for the channel information of the first channel is received, invoking a player to play back the video data of the first channel.

In a preferred embodiment of the disclosure, the first channel playback module may include following sub-modules:

a sending sub-module, configured to send a channel module list of a channel category to which the first channel pertains and a first position of the first channel in the channel module list to the player;

a loading sub-module, configured to load a first channel display window;

a second displaying sub-module, configured to, when the stream address of the first channel is being loaded by the player, display the channel information of the first channel on the first channel display window; and

a second removing sub-module, configured to, when the stream address of the first channel is completely loaded by the player, remove the first channel display window, wherein the stream address of the first channel is obtained by locating the first position in the channel module list of the channel category to which the first channel pertains by the player.

In a specific implementation, the first channel display window may include a first image floating layer and/or a first text floating layer, the second channel display window may include a second image floating layer and/or a second text floating layer, and the channel information may contain channel images and/or channel texts.

The first image floating layer may be used to display the channel images, and the second image floating layer may be used to display the channel images.

The first text floating layer may be used to display the channel texts, and the second text floating layer may be used to display the channel texts.

Since the device embodiments are substantially similar to the method embodiments, the description thereof is relatively brief. As for the related parts thereof, reference may be made to the relevant description of the method embodiment

The various embodiments in the specification have been explained step by step. Each of the embodiments has only emphasized the differences from others, and the same or similar parts between embodiments could be referred to each other.

It should be understood by those skilled in the art, embodiments of in the disclosure could be provided as a method, a device and a computer program product. Therefore, the embodiments of the disclosure may employ the forms of complete hardware embodiment, complete software embodiment or combination of hardware and software. Further, the embodiments of in the disclosure may employ the form of computer program product realizable on one or more of computer available recording medium (including but not limited to magnetic disk storage medium, CD-ROM and optical storage medium, for example) containing computer available program codes.

The embodiments of in the disclosure have been described with reference to flow chart and/or block diagram of method, terminal device (system) and computer program product. It should be understood that each of steps and/or modules in flow chats and/or block diagrams, and combination of steps and/or modules in flow chats and/or block diagrams could be realized by computer program instructions. The computer program instructions may be provided for a universal computer, a dedicated computer, an embedded processor or a processor of other programmable data processing terminal device to generate a machine, such that the instructions executed by the computer or the processor of other programmable data processing terminal device may form devices for realizing functions specified by one or more steps in the flow charts and/or one or more modules in the block diagrams.

The computer program instructions may also be stored in computer readable memory capable of booting the computer or other programmable data processing terminal device to run in a designated mode, such that the instructions stored in the computer readable memory may form a manufactured product containing instruction device. The instruction device may realize functions specified by one or more steps in the flow charts and/or one or more modules in the block diagrams.

The computer program instructions may also be loaded into the computer or other programmable data processing terminal device, such that the computer or other programmable terminal device may execute a series of operation steps to generate processing realizable by the computer, and in turn the instructions executed on the computer or other programmable terminal device may provide steps for realizing functions specified by one or more steps in the flow charts and/or one or more modules in the block diagrams.

Although preferred embodiments of the disclosure have been described, those skilled in the art may make additional amendments and modifications to the embodiments with substantial creative concept thereof. Therefore, the appended claims are intended to be constructed as encompassing the preferred embodiments and all the amendments and modifications falling into the scope of the embodiments of the disclosure.

In the end, it will be explained that, the terms “first”, “second”, etc. are only used herein to distinguish one element or operation from another element or operation, and does not necessarily require or suggest that there are any actual relationship or sequence between these elements or operations. Further, the terms “comprise”, “include” and any other variants thereof are intended to cover a non-exclusive “comprise”, so that process, method, product or terminal device which includes a series of elements may include not only those elements but also other elements that do not be definitely listed herein, or also may include inherent elements of the process, method, product or terminal device. In the absence of more restrictions, an element defined by the statement “includes a . . . ” is not meant to exclude other same elements in the process, method, product or terminal device including this element.

The method for switching channel and the device for switching channel provided in the disclosure have been described in detail. Herein the principles and implementations of the disclosure are illustrated by way of specific examples. The embodiments described above are only intended to help understand the method and main concept of the disclosure. Meanwhile, for an ordinary person skilled in the art, variations could be made to the specific embodiments and their application scope in accordance with the concept of the disclosure. In summary, the contents of the specification should not be construed as limiting of the disclosure.

What is claimed is:

1. A method for switching channel, characterized in that the method comprises steps of:
when a first touch gesture for a first channel is detected, loading a first channel display window;
displaying channel information of the first channel on the first channel display window;
according to a detected second touch gesture, moving at least a portion of channel information of the first channel out of and moving at least a portion of channel information of a second channel into the first channel display window; and
when the moved-out channel information of the first channel or the moved-in channel information of the second channel satisfies a predefined switching condition, playing back video data of the second channel.

2. The method according to the claim 1, characterized in that, the step of, according to a detected second touch gesture, moving at least a portion of channel information of the first channel out of and moving at least a portion of channel information of a second channel into the first channel display window, comprises:
when the second touch gesture is detected, determining the second channel at a second position in a channel module list of a channel category to which the first channel pertains according to a direction of the second touch gesture, the second position being adjacent to a first position of the first channel;
obtaining channel information of the second channel; and
according to the second touch gesture, moving at least a portion of channel information of the first channel out of and moving at least a portion of channel information of the second channel into the first channel display window.

3. The method according to the claim 1, characterized in that, the step of playing back video data of the second channel comprises:
when stream address of the second channel is being loaded by a player, displaying the channel information of the second channel on the first channel display window; and
when stream address of the second channel is completely loaded by a player, removing the first channel display window,
wherein the stream address of the second channel is obtained by searching the channel module list of the channel category to which the second channel pertains by the player.

4. The method according to the claim 1, characterized in that, a current first display interface of electronic terminal comprises at least one category channel display region, the category channel display region comprises a first display sub-region and at least one second display sub-region, the first display sub-region is used to display a channel category identifier, the second display sub-region is used to display a second channel display window, and the second channel display window is used to display channel information corresponding to a channel in the channel category.

5. The method according to the claim 1 characterized in that, prior to the step of loading the channel information of the first channel on the first floating layer, the method further comprises:
displaying channel information of a channel on at least one second channel display window, the channel including a first channel; and
when a playback instruction for the channel information of the first channel is received, invoking a player to play back the video data of the first channel.

6. The method according to the claim 5, characterized in that, the step of invoking an interface of a player to play back the video data of the first channel comprises:
sending a channel module list of a channel category to which the first channel pertains and a first position of the first channel in the channel module list to the player;
loading the first channel display window;
when the stream address of the first channel is being loaded by the player, displaying the channel information of the first channel on the first channel display window;
when the stream address of the first channel is completely loaded by the player, removing the first channel display window, wherein the stream address of the first channel is obtained by locating the first position in the channel module list of the channel category to which the first channel pertains by the player.

7. The method according to the claim 4, characterized in that, the first channel display window comprises a first image floating layer and/or a first text floating layer, the second channel display window comprises a second image floating layer and/or a second text floating layer, the channel information contains channel images and/or channel texts;
the first image floating layer is used to display the channel images, and the second image floating layer is used to display the channel images; and
the first text floating layer is used to display the channel texts, and the second text floating layer is used to display the channel texts.

8. An electronic terminal for switching channel, characterized in that, the electronic terminal comprises:
at least one processor;
a memory for storing at least one instruction executable by the processor;
wherein the processor is configured to perform:
when a first touch gesture for a first channel is detected, loading a first channel display window;
displaying channel information of the first channel on the first channel display window;
according to a detected second touch gesture, moving at least a portion of channel information of the first channel out of and move at least a portion of channel information of a second channel into the first channel display window; and
when the moved-out channel information of the first channel or the moved-in channel information of the second channel satisfies a predefined switching condition, playing back video data of the second channel.

9. The electronic terminal according to claim 8, characterized in that, according to a detected second touch gesture, moving at least a portion of channel information of the first channel out of and move at least a portion of channel information of a second channel into the first channel display window further comprises:
when the second touch gesture is detected, determining the second channel at a second position in a channel module list of a channel category to which the first channel pertains according to a direction of the second touch gesture, the second position being adjacent to a first position of the first channel;
obtaining channel information of the second channel; and
according to the second touch gesture, moving at least a portion of channel information of the first channel out of and moving at least a portion of channel information of the second channel into the first channel display window.

10. The electronic terminal according to claim 8, characterized in that, when the moved-out channel information of the first channel or the moved-in channel information of the second channel satisfies a predefined switching condition, playing back video data of the second channel further comprises:
when stream address of the second channel is being loaded by a player, displaying the channel information of the second channel on the first channel display window; and
when stream address of the second channel is completely loaded by a player, removing the first channel display window,
wherein the stream address of the second channel is obtained by searching the channel module list of the channel category to which the second channel pertains by the player.

11. The electronic terminal according to claim 8, characterized in that, a current first display interface of electronic terminal comprises at least one category channel display region, the category channel display region comprises a first display sub-region and at least one second display sub-region, the first display sub-region is used to display a channel category identifier, the second display sub-region is used to display a second channel display window, and the second channel display window is used to display channel information corresponding to a channel in the channel category.

12. The electronic terminal according to claim 8, characterized in that, the processor is further configured to perform:
displaying channel information of a channel on at least one second channel display window, the channel including a first channel; and
when a playback instruction for the channel information of the first channel is received, invoking a player to play back the video data of the first channel.

13. The electronic terminal according to claim 12, characterized in that, when a playback instruction for the channel information of the first channel is received, invoking a player to play back the video data of the first channel further comprises:
sending a channel module list of a channel category to which the first channel pertains and a first position of the first channel in the channel module list to the player;
loading a first channel display window;
when the stream address of the first channel is being loaded by the player, displaying the channel information of the first channel on the first channel display window; and
when the stream address of the first channel is completely loaded by the player, removing the first channel display window, wherein the stream address of the first channel is obtained by locating the first position in the channel module list of the channel category to which the first channel pertains by the player.

14. The electronic terminal according to claim 11, characterized in that, the first channel display window comprises a first image floating layer or a first text floating layer, the second channel display window comprises a second image floating layer or a second text floating layer, the channel information contains channel images or channel texts;
the first image floating layer is used to display the channel images, and the second image floating layer is used to display the channel images; and
the first text floating layer is used to display the channel texts, and the second text floating layer is used to display the channel texts.
